(19) United States
(12) Patent Application Publication
(10) Pub. No.: US 2007/0179826 A1
(43) Pub. Date: Aug. 2, 2007

(54) Creating a modified ontological model of a business machine

(75) Inventors: Robert R. Cutlip, Cary, NC (US); Mandar U. Jog, Cary, NC (US); Neeraj R. Joshi, Morrisville, NC (US)

Correspondence Address: STEVENS & SHOWALTER, L.L.P., BOX IBM, 7019 CORPORATE WAY, DAYTON, OH, 45459-4238, US

(73) Assignee: International Business Machines Corporation, Armonk, NY (US)

(21) Appl. No.: 11/345,010

(22) Filed: Feb. 1, 2006

(51) Int. Cl. G06F 9/44

(52) U.S. Cl. 705/7

(57) ABSTRACT

Services of a business process are selected for execution. Ontological data is read from a data source corresponding to sub-process sets of the business process. Each sub-process set comprises at least one service. A first ontological model is generated from the read ontological data. Performance characteristics are read for at least one service. Real time or near real time knowledge information is read regarding resources of a system for executing the business process. A modified ontological model is generated from the read performance characteristics and the real time or near real time system resource knowledge information.

### CROSS-REFERENCE TO RELATED APPLICATIONS

This application is related to commonly assigned and co-pending U.S. patent application Ser. No. 11/069,721, filed Feb. 28, 2005, entitled “Method and Computer Program Product for Generating a Lightweight Ontological Data Model”; U.S. patent application Ser. No. 11/067,341, filed Feb. 25, 2005, entitled “Method and Computer Program Product for Dynamic Weighting of an Ontological Data Model”; and U.S. patent application Ser. No. 11/067,861, filed Feb. 28, 2005, entitled “Method and Computer Program Product for Enabling Dynamic and Adaptive Business Processes Through an Ontological Data Model”; all of which are hereby incorporated by reference.

### BACKGROUND OF THE INVENTION

The present invention relates a method, system and computer program product for creating a modified ontological model of a business process.

Enterprise systems are increasingly integrating various business systems and processes to facilitate data collaboration among various software systems. Business processes may be implemented in a proprietary software language or may be implemented using an industry standard language, such as the Business Process Execution Language (BPEL). Business processes define workflows that generally include a variety of tasks. Typically, managing the collaborative sharing of information in a business enterprise system is difficult.

Networks such as the Internet provide the ability for geographically diverse systems to communicate with very low latency with other systems or individuals. Many enterprise systems once limited to enterprise intranets are now being deployed on the Internet to exploit available Web services. However, in doing so, effective implementation of a business process requires integration of even more diverse data and systems. As such, effective implementation of business processes is becoming even more complex.

### BRIEF SUMMARY OF THE INVENTION

The present invention provides a method, computer program product and a data processing system for creating a modified ontological model of a business process. Ontological data is read from a data source corresponding to sub-process sets of the business process. Each sub-process set comprises at least one service. A first ontological model is generated from the read ontological data. Performance characteristics are read for at least one service. Real time or near real time knowledge information is read regarding resources of a system for executing the business process. A modified ontological model is generated from the read performance characteristics and the real time or near real time system resource knowledge information.

### BRIEF DESCRIPTION OF THE SEVERAL VIEWS OF THE DRAWINGS

FIG. 1 depicts a pictorial representation of a network system in which the present invention may be implemented;

FIGS. 2-4 provide diagrammatic illustrations of an embodiment of the present invention for optimizing a business process;

FIG. 5 is a diagrammatic illustration of system resources and local and global managers for controlling and monitoring the resources; and

FIG. 6 is a flowchart defining steps for optimizing a business process in accordance with an embodiment of the present invention.

### DETAILED DESCRIPTION OF THE INVENTION

As will be appreciated by one skilled in the art, the present invention may be embodied as a method, system, or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product on a computer-usable storage medium having computer-usable program code embodied in the medium.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

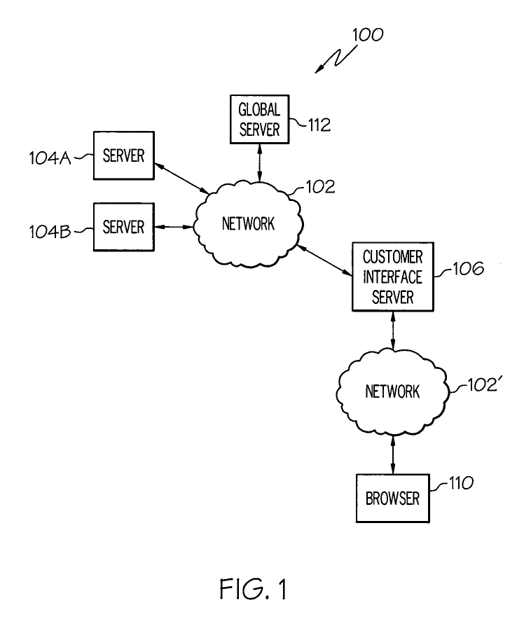

With reference now to the figures, FIG. 1 depicts a pictorial representation of a communications network system 100 in which the present invention may be implemented. Network system 100 contains first and second networks 102 and 102′, which are used to provide communications links between various devices and computers connected together within the network system 100. Networks 102 and 102′ may include connections, such as wire, wireless communication links, or fiber optic cables. In the illustrated embodiment, networks 102 and 102′ comprise the Internet.

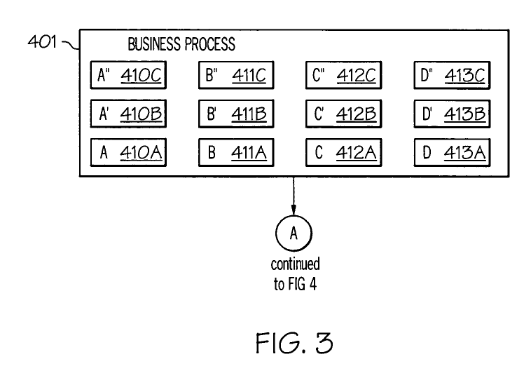

One or more services of a business process may be provided by servers 104A and 104B. A customer interface server 106 may be used to control the overall operation of a computer-implemented business process 401, see FIG. 3. Browser 110 may be used by a customer to communicate a request to the customer interface server 106. An autonomic global manager 600, discussed below, may run on the global server 112.

The computer-implemented business process 401 may describe and define a business process or workflow that has one or more sub-processes or services. An example of a computer-implemented business process is a business transaction for the sale and delivery of a product. A buyer may place an order for the product using a browser 110. The request or order travels over network 102′ to the customer interface server 106, which may be controlled by the seller. Some of the processing steps undertaken by the seller may involve business process services that are external to the seller and, hence, may be performed by servers 104A and 104B in response to requests generated by the server 106. The requests generated by the server 106 travel to the servers 104A and 104B via the network 102. For example, the seller may obtain products from one or multiple third-party suppliers and hence may need to contact an appropriate supplier for the current pricing and availability of a particular product; many on-line sellers often use third-party credit checking services to process credit card payments; and shipping may also be contracted to a third party shipping company. A business process execution language, such as Business Process Execution Language for Web Services (BPEL4WS), may be used to integrate third party services to the seller's server 106. BPEL4WS is used to describe business processes and is based on Extensible Markup Language (XML) specifications. For example, the seller's server 106 may be programmed to directly call a supplier's service (e.g., server 104A) to obtain information on the product being sold. The step of calling the supplier and receiving product information from the supplier may be considered one sub-process or service of the business process 401. A step of contacting a third-party credit checking service to process a credit card payment may comprise another sub-process or service of the business process 401. A step of contacting a third-party shipping company to arrange for shipping of the product may comprise a further sub-process or service of the business process. The seller, upon receiving a product from a supplier, may package the product using the seller's own label, such that this packaging step could comprise a further sub-process or service of the business process. It is also contemplated that network 102 may comprise an intranet or other network such as where the business process services running on servers 104A, 104B are controlled by the seller.

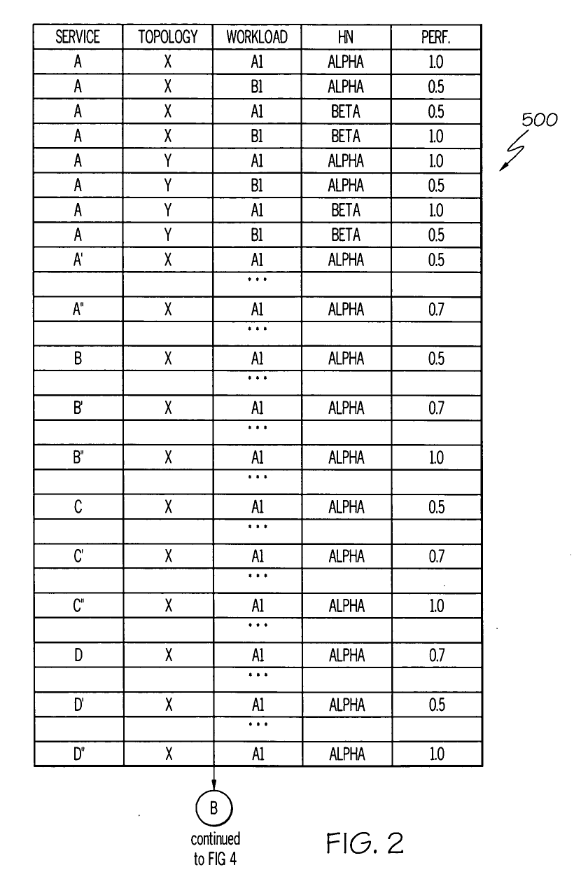

With reference now to FIGS. 2-4, a diagrammatic illustration is provided of an embodiment of the present invention for optimizing a computer-implemented business process 401. Computer-implemented business process 401 may define more sub-processes or services than those which will be carried out during execution of a final or optimized computer-implemented business process 401′. In the illustrative example, business process 401 comprises a plurality of sub-processes 410A-413C, or services, see FIG. 3. Sub-processes or services, e.g., 410A-410C, of a sub-process set, e.g., 410, define related services that deviate in some manner. For example, related services of a given sub-process set may comprise different algorithms, may operate differently on a given topology, may have different workload patterns and/or may have different hardware requirements. However, each of the services, e.g., 410A-410C, within a given sub-process set, e.g., 410, have the same inputs, outputs, pre-conditions and post-conditions. In the illustrative example, four sub-process sets 410-413 respectively comprising sub-processes or services 410A-410C, 411A-411C, 412A-412C and 413A-413C are provided, see FIG. 3. An example of three different services of a common sub-process set may comprise three different suppliers of the same product.

At any given execution cycle of the business process 401, a sub-process or service of a sub-process set may be executed while other sub-processes or services of the same sub-process set are not executed. Also, it is possible that no single service of a particular sub-process set will be executed during an execution cycle of the business process 401.

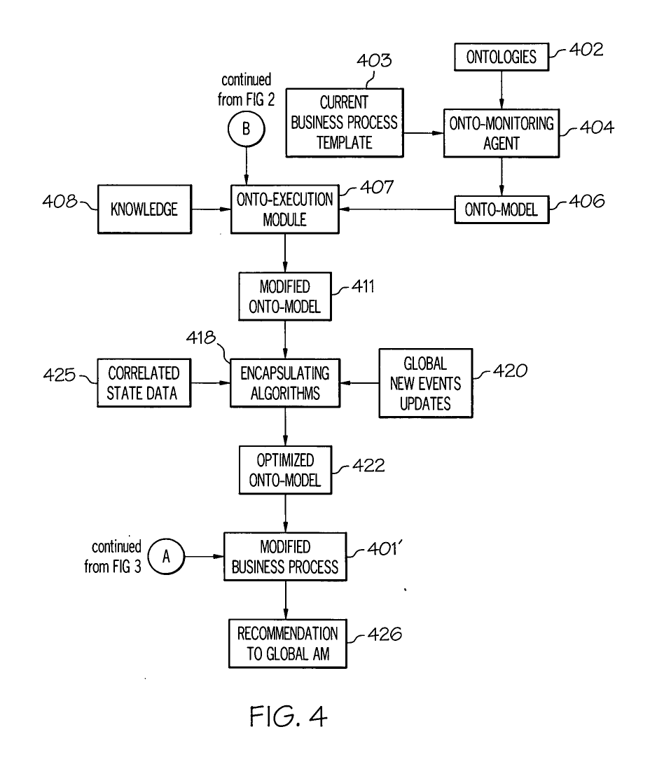

Referring now to FIG. 4, an ontology store 402 defines ontologies, e.g., relationships, such as required inputs, outputs, preconditions, and post-conditions required for interactions among various sub-process sets 410-413. A template store 403 defines constraints of the business process 401. For example, the template store 403 defines for each sub-process set that: at least one service of that sub-process set must be executed; the sub-process set is optional; or the sub-process set is irrelevant and should not be invoked. Onto-monitoring agent 404 reads ontological data from the ontology store 402 and constraints from the template store 403 and generates an onto-model 406 therefrom. The onto-model 406 comprises a directed graph having directed links connected to related sub-process sets or nodes. Two sub-process sets are considered related if the outputs and post-conditions of a first sub-process set are the same as the inputs and pre-conditions of a second sub-process set. The onto-model 406 may not comprise all of the available sub-process sets 410-413, as one or more sub-process sets may be optional and not related to another sub-process set or one or more sub-process sets may be irrelevant. Further, the onto-model 406 does not at this juncture define a preferred individual service from each selected sub-process set.

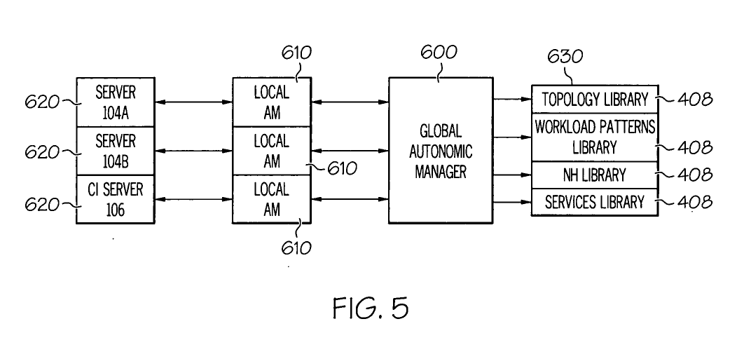

The onto-model 406 is provided to an onto-execution module 407. The onto-execution module 407 reads performance characteristics for the individual services 410A-413C from a look-up table 500, see FIG. 2, and data from knowledge source libraries 408. The data from the knowledge source libraries 408 comprises real or near real time knowledge information regarding one or more resources of the system 100 for executing the business process 401. Based on the onto-model 406, the performance characteristics and the knowledge source library data, the module 407 creates a modified onto-model 411. The modified onto-model 411 will have a single service, e.g., 410C, defined for each selected sub-process set, e.g., 410, contained in the onto-model 406, and a weight assigned to each link connecting related services. The modified onto-model 411 is then supplied to an encapsulating algorithm 418 for determining an optimized onto-model 422, wherein an optimal path from a source or initial service in the modified onto-model 411 to a destination or final service in the modified onto-model 411 is defined. State data store 425 comprising real time performance and availability data for all currently running services 410A-413C and corresponding resources and global new event updates such as business policy information provided by the global autonomic manager 600, see FIG. 5, are considered by the encapsulating algorithm 418 in determining the optimized onto-model 422. The optimized onto-model 422 is mapped onto the business process 401 to generate an optimized computer-implemented business process 401′, i.e., business process execution language defining the optimized business model 401′ is generated. For example, the optimized business process 401′ may comprise services 410A, 411C, 412B and 413D. The optimized business process 401′ is communicated to the global autonomic manager 600 for controlling the implementation of the optimized business process 401′.

In FIG. 5, the global autonomic manager 600 is illustrated as being in communication with a plurality of local autonomic managers 610. Each local manager 610 is associated with a corresponding resource 620. In FIGS. 1 and 5, three resources 620 of the system 100 are illustrated comprising the servers 104A, 104B and the corresponding application software running on those servers (hardware units) as well as the customer interface server 106 and the application software running on that server (hardware unit(s)). Server 104A may correspond to service 410A and server 104B may correspond to service 411C. There may also be a separate server (not shown) for each of services 412B and 413D. Each local manager 610 may comprise a software component running on a respective server for managing the operation of its corresponding resource 620 to improve its performance. Each local manager 610 also monitors the performance of its corresponding resource 620 and provides performance-related information to the global autonomic manager 600. In the embodiment illustrated in FIGS. 1 and 5, the local manager 610 corresponding to the application software/server 104A may be running on the server 104A; the local manager 610 corresponding to the application software/server 104B may be running on the server 104B; and the local manager 610 corresponding to the application software/server 106 may be running on the server 106. The system 100 may comprise additional resources and corresponding local autonomic managers 610, which are not shown. For example, for a business process 401 having services 410A-413C, there may be a separate resource, i.e., an application software/server, for each of the services 410A-413C. The global manager 600 may comprise a software component running on the global server 112, for managing the operation of all local managers 610 and resources 620 so as to improve the performance of all resources 620.

The global manager 600 also updates the knowledge source libraries 108 stored in a knowledge store 630. The knowledge store 630 may comprise a database in the global server 112 or a separate hardware unit. A topology library, a workload patterns library, a normalized hardware library and a services library may be maintained in the knowledge store 630 and define the knowledge source libraries 108. The topology library defines a list of valid resource arrangements for the overall system 100 upon which the business process is implemented, the date of the last instantiation or invocation of each resource arrangement and the resource arrangement currently in use. The workload patterns library defines historic workloads as a function of time for the overall system 100 upon which the business process is implemented and a current workload for the system 100. A normalized hardware library defines one or more predefined metrics corresponding to capabilities, e.g., memory and/or performance capabilities, for a hardware unit or a predefined combination of hardware units currently in the system capable of running each of the services 410A-413C. The services library defines, for example, the services 410A-413C and corresponding resources currently in use within the system 100, how each service 410A-413C and corresponding resource(s) may be invoked and historical performance data for each service and corresponding resource(s). The topology library, the workload patterns library and the normalized hardware library may be updated by the global manager 600 on a near real time basis and the services library may be updated by the global manager 600 on a real time basis.

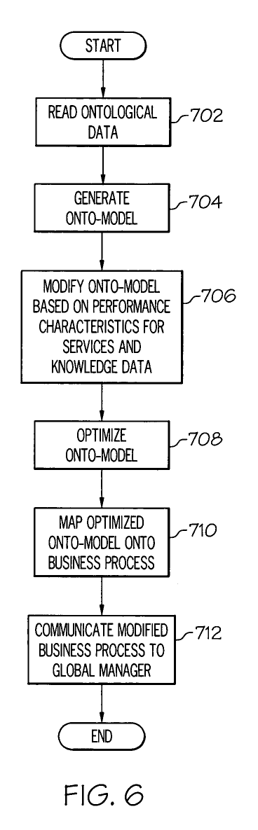

With reference now to FIG. 6, a flowchart is provided which defines an algorithm to optimize the business process 401 for each execution cycle of the business process 401, i.e., each time the business process 401 is run. The steps in FIG. 6 may be implemented, for example, by servers 104A, 104B, 106, and 112, illustrated in FIG. 1, defining at least a portion of the system 100 for executing the optimized business process 401′.

The onto-monitoring agent 404 reads ontological data, step 702, from the ontology store 402 shown in FIG. 4. The onto-monitoring agent 404 also reads business process constraints from the template store 403. As noted above, the template store 403 defines for each sub-process set that: at least one service of that sub-process set must be executed; the sub-process set is optional; or the sub-process set is irrelevant and should not be invoked. Based on the ontological data read from the ontology store 402 and the constraints read from the template store 403, the onto-monitoring agent 404 generates an onto-model 406, see step 704. The onto-model 406 comprises a directed graph having directed links connected to related sub-process sets or nodes. To form a directed graph, the onto-monitoring agent 404 determines for each sub-process set, for example, set 410, its outputs and post-conditions and determines which of the remaining sub-process sets, e.g., sets 411-13, have required inputs and pre-conditions identical to the outputs and post-conditions of the sub-process set 410. For each sub-process set having inputs and pre-conditions equal to the outputs and post-conditions of the sub-process set being reviewed, e.g., set 410, a directed link is provided between those sub-process sets. Hence, if sub-process sets 411 and 412 have inputs and pre-conditions equal to the outputs and post-conditions of sub-process set 410, a directed link is provided between sub-process set 410 and sub-process set 411 and another directed link is provided between sub-process set 410 and sub-process set 412. If no directed link extends to a sub-process set, then that set is not included in the directed graph. Hence, the onto-model 406 may not comprise all of the available sub-process sets 410-413, as one or more sub-process sets may be optional and not related to another sub-process set or one or more sub-process sets may be irrelevant.

The onto-monitoring agent 404 may be implemented by software operating on the server 106, and the ontology store 402 and template store 403 may define databases within the server 106.

In step 706, the onto-model is modified based on performance characteristics for each individual service 410A-413C and data from knowledge libraries 408.

The onto-model 406 is provided to the onto-execution module 407. The onto-execution module 407 reads the performance characteristics for the individual services 410A-413C from the look-up table 500, see FIG. 2, and knowledge data from the knowledge source libraries 108 in the knowledge store 630, noted above. As noted above, the knowledge source libraries 408 may comprise a topology library, a workload patterns library, a normalized hardware library and a services library.

The look-up table 500 contains for each service 410A-413C all combinations of the following: 1) predefined topologies in which the system 100 may be configured; in the illustrated embodiment, a first topology X and a second topology Y are defined for the system 100; 2) predefined workloads for the system 100; in the illustrated embodiment a light workload A1 and a heavy workload B1 are predefined for the system 100; 3) hardware normalization (HN); in the illustrated embodiment a first performance capability “Alpha” and a second performance capability “Beta” are predefined and may be assigned to each hardware unit or a combination of two or more hardware units capable of running any given service 410A-413C; and an overall performance value for the service based on the corresponding topology, workload and hardware normalization. The look-up table 500 may be updated from time to time by the global manager 600 as topologies are added or removed and/or as new performance data is consolidated.

Based on the onto-model 406, the performance characteristics in the look-up table 500 and the knowledge source libraries 408, the module 407 defines a single service for each corresponding sub-process set. For example, when the module 407 determines whether to select service A, A′ or A″ as the preferred service for sub-process set 410, it consults the knowledge source libraries 108 to determine, as of the time the libraries 108 were last updated by the global manager 600, the topology of the system 100, the workload of the system 100 and the hardware normalization for all hardware units currently in the system 100 capable of running services A, A′ and/or A″. In this example, it is presumed that, as of the last update of the libraries 408 by the global manager 600, the topology of the system 100 was X, the workload of the system was A1 and the hardware normalization for the one or more hardware units currently in the system capable of running services 410A-410C was Alpha. The module 407 then determines from the look-up table 500 the performance value for each of services A, A′ and A″ operating within a system having a topology of X and a workload of A1 and running on a hardware unit(s) having a hardware normalization of Alpha. From FIG. 2, it is apparent that service A operating within a system having a topology of X and a workload of A1 and running on a hardware unit(s) having a hardware normalization of Alpha, has a performance level of 1.0; service A′ operating with a system having a topology of X and a workload of A1 and running on a hardware unit(s) having a normalization of Alpha, has a performance level of 0.5; and service A″ operating within a system having a topology of X and a workload of A1 and running on a hardware unit(s) having a normalization of Alpha, has a performance level of 0.7. Since service A (also referred to as service 410A) has the highest performance level, service 410A is selected by the module 407 as the preferred service for sub-process set 410. A similar operation is performed by the module 407 to determine a preferred service for the remaining sub-process sets 411-413.

Hence, the modified onto-model 411 includes a single service, e.g., 410A, defined for each sub-process set, e.g., 410, or node previously defined in the onto-model 406. Further, the onto-execution module 407 assigns a weight to each directed link connecting related services or nodes. The weight is equal to the performance value for a second of two linked services or nodes. For example, if the outputs and post-conditions for service 410A equal the inputs and preconditions for service 411C, then the directed link between services 410A and 411C will be assigned a weight equal to the performance value for the service 411C, which performance value is selected from the look-up table 500 based on the topology, workload and hardware normalization corresponding to the selected service 411C.

The look-up table 500 may be stored in a database associated with server 106 and the onto-execution module 407 may be executed by the server 106.

In step 708, the modified onto-model 411 is then supplied to an encapsulating algorithm 418 for determining an optimized onto-model 422, wherein an optimal path from a source or initial service in the modified onto-model 411 to a destination or final service in the modified onto-model 411 is defined. The encapsulating algorithm 418 may include one or more evaluation algorithms such as a Dijkstra's or a Bellman-Ford algorithm. State data store 425 comprising real time performance and availability data for all currently running services 410A-413C and corresponding resources provided by the global autonomic manager 600 and global new event updates such as business policy information provided by the global autonomic manager 600 are considered by the encapsulating algorithm 418 in determining the optimized onto-model 422. The state data store 425 and the global new event updates 420 may be stored in databases associated with the server 112 and the encapsulating algorithm may be executed by the server 106.

The performance and availability data for all currently running services 410A-413C and corresponding resources in state data store 425 is real time data, which may differ from the predefined performance data stored in the look-up table 500. The real time performance and availability data may indicate to the encapsulating algorithm 418 that a selected service in the modified onto-model is performing below par, i.e., below the corresponding performance value stored in the look-up table, or is not in service. Based on this information, the encapsulating algorithm 418 may designate a replacement service for use in the optimized onto model 422 for the one underperforming or not in service. Alternatively, the encapsulating algorithm 418 may return to step 706 of the evaluating algorithm in FIG. 6 for re-execution of step 706. The encapsulating algorithm 418 will also indicate to the onto-execution module 407 that the underperforming service or service not in use is unavailable and should be ignored.

The global new events updates provided by the global autonomic manager 600 may comprise business policies such that a particular server should not be loaded beyond 80% capacity; whenever two or more services, e.g., A and A′, forming part of a sub-process set, e.g., 410, have the same performance level as defined in the look-up table 500, pick a specified service, e.g., A′; a catastrophic event has occurred and the server 106 running the algorithm to optimize the business process 401, as set out in FIG. 6, should re-start the algorithm at step 702. If a global new events updates indicates that a catastrophic event has occurred, the encapsulating algorithm 418 may cause the evaluating algorithm set out in FIG. 6 to be restarted at step 702. If a global new events updates indicates that a particular service, e.g., service 410A, is unavailable, the encapsulating algorithm 418 may return to step 706 of the evaluating algorithm in FIG. 6 for re-execution of step 706. The encapsulating algorithm 418 will also indicate to the onto-execution module 407 that service 410A is unavailable and should be ignored.

In step 710, the optimized onto-model 422 is mapped onto the business process 401 to generate an optimized computer-implemented business process 401′, i.e., business process execution language defining the optimized business process 401′ is generated. For example, the modified business process 401′ may comprise services 410A, 411C, 412B and 413D.

In step 712, the modified business process 401′ is communicated to the global autonomic manager 600 for controlling the implementation of the optimized business process 401′.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to preferred embodiments thereof, it will be apparent that modifications and variations are possible without departing from the scope of the invention defined in the appended claims.

What is claimed is:

1. A method of creating a modified ontological model of a business process comprising:
reading ontological data from a data source corresponding to sub-process sets of the business process, each sub-process set comprising at least one service;
generating a first ontological model from the read ontological data;
reading performance characteristics for at least one service;
reading real time or near real time knowledge information regarding resources of a system for executing the business process; and
generating a modified ontological model from the read performance characteristics and the real time or near real time system resource knowledge information.

2. A method as set forth in claim 1, wherein reading performance characteristics for at least one service comprises reading predefined performance information for at least one service.

3. A method as set forth in claim 1, wherein said reading real time or near real time system resource knowledge information comprises reading at least one of a topology library, a workload patterns library, a normalized hardware library and a services library.

4. A method as set forth in claim 3, further comprising updating said topology library, said workload patterns library, and said normalized hardware library on a near real time basis and the services library on a real time basis.

5. A method as set forth in claim 1, wherein the ontological data comprises one or more of an input, an output, a precondition, and post-condition for each sub-process set and said first ontological model is implemented as a directed graph having directed links interconnecting related nodes, wherein each node corresponds to a sub-process set.

6. A method as set forth in claim 5, wherein said generating a modified ontological model comprises selecting for each node the most satisfactory service from the corresponding sub-process set and assigning a weighted value to each directed link to facilitate navigation of the modified ontological model.

7. A system for creating a modified ontological model of a business process comprising:
a module to read ontological data from a data source corresponding to sub-process sets of the business process, each sub-process set comprising at least one service;
a module to generate a first ontological model from the read ontological data;
a module to read performance characteristics for at least one service;
a module to read real time or near real time knowledge information regarding resources of a system for executing the business process; and
a module to generate a modified ontological model from the read performance characteristics and the real time or near real time system resource knowledge information.

8. A system as set forth in claim 7, wherein said module to read performance characteristics for at least one service reads predefined performance information for one or more services.

9. A system as set forth in claim 7, wherein said module to read real time or near real time system resource knowledge information reads at least one of a topology library, a workload patterns library, a normalized hardware library and a services library.

10. A system as set forth in claim 9, further comprising a module to update said topology library, said workload patterns library, and said normalized hardware library on a near real time basis and the services library on a real time basis.

11. A system as set forth in claim 7, wherein the ontological data comprises one or more of an input, an output, a precondition, and post-condition for each sub-process set and said module to generate a first ontological model generates a directed graph having directed links interconnecting related nodes, wherein each node corresponds to a sub-process set.

12. A system as set forth in claim 11, wherein said module to generate a modified ontological model selects for each node the most satisfactory service from the corresponding sub-process set and assigns a weighted value to each directed link to facilitate navigation of the modified ontological model.

13. A computer program product for creating a modified ontological model of a business process, the computer program product comprising:
a computer usable medium having computer usable program code embodied herewith, the computer usable program code comprising:
computer usable program code configured to read ontological data from a data source corresponding to sub-process sets of the business process, each sub-process set comprising at least one service;
computer usable program code configured to generate a first ontological model from the read ontological data;
computer usable program code configured to read predefined performance information for at least one service;
computer usable program code configured to read real time or near real time knowledge information regarding resources of a system for executing the business pro computer usable program code configured to generate a modified ontological model from the read predefined performance information and the real time or near real time system resource knowledge information.

14. A computer program product as set forth in claim 13, wherein said computer usable program code to read predefined performance information for at least one service reads predefined performance information for at least one service.

15. A computer program product as set forth in claim 13, wherein said computer usable program code to read system resource knowledge information reads at least one of a topology library, a workload patterns library, a normalized hardware library and a services library.

16. A computer program product as set forth in claim 15, further comprising computer readable code to update said topology library, said workload patterns library, and said normalized hardware library on a near real time basis and the services library on a real time basis.

17. A computer program product as set forth in claim 13, wherein the ontological data comprises one or more of an input, an output, a precondition, and post-condition for each sub-process set and said computer usable program code to generate a first ontological model generates a directed graph having directed links interconnecting related nodes, wherein each node corresponds to a sub-process set.

18. A computer program product as set forth in claim 17, wherein said computer readable code to generate a modified ontological model selects for each node the most satisfactory service from the corresponding sub-process set and assigns a weighted value to each directed link to facilitate navigation of the modified ontological model.
